(19) United States
(12) Patent Application Publication
(10) Pub. No.: US 2024/0021037 A1
(43) Pub. Date: Jan. 18, 2024

(54) SENSOR AND METHOD FOR VERIFYING VALUE DOCUMENTS

(71) Applicant: GIESECKE+DEVRIENT CURRENCY TECHNOLOGY GMBH, Munchen (DE)

(72) Inventors: Dieter STEIN, Holzkirchen (DE); Norbert HOLL, Germering (DE); Steffen SCHMALZ, Munchen (DE)

(21) Appl. No.: 18/039,771

(22) PCT Filed: Dec. 1, 2021
(86) PCT No.: PCT/EP2021/000152

§ 371 Date: Jun. 1, 2023

(30) Foreign Application Priority Data
Dec. 1, 2020 (DE) 102020007322.0

(51) Int. Cl. G07D 7/202; G06V 20/00; G06T 7/73; G06V 30/42

(52) U.S. Cl. CPC G07D 7/2041; G06V 20/95; G06T 7/73; G06V 30/42; G07D 2207/00; G06T 2207/30176

(57) ABSTRACT

The invention relates to a sensor for verifying value documents, which has a plurality of fibres that are distributed over the value document and have a characteristic optical or magnetic signal. The sensor has an image capture device for spatially resolved detection of optical or magnetic signals of the value document, which device is designed to capture a value document image of the value document. Furthermore, the sensor has an analysis device which, for the purpose of analysing the value document, is designed to locate the fibres in the value document image and determine at least one local fibre characteristic value for one or more different locations of the value document image in each case and classify the value document as suspected counterfeit on the basis of the local fibre characteristic value. If the value documents are processed automatically, the suspected counterfeit value document can then be automatically rejected.

The present invention relates to a sensor and a method for verifying value documents.

Value documents are understood here to mean sheetlike objects which represent e.g. a monetary value or an authorization and therefore ought not to be arbitrarily producible by unauthorized parties. Therefore, they comprise security features which are not easy to produce and the presence of which is an indication of authenticity. Important examples of such value documents are smart cards, coupons, vouchers, checks and in particular banknotes. The value documents may each differ in terms of their type, for example—in the case of banknotes—in terms of the denomination or the nominal value and the currency or—in the case of checks—a check form type provided by the issuer of the checks.

For safeguarding against counterfeits, it is known to equip value documents with magnetic fibers that supply a characteristic magnetic signal, or with fibers that supply a characteristic optical signal, e.g. a characteristic reflection or luminescence. Value documents are often equipped with luminescent mottled fibers distributed over their area in a specific manner or randomly. Such mottled fibers are usually added to the paper substrate of the value documents during the production of the value documents. It is known to optically excite value documents equipped with mottled fibers and to check the mottled fiber luminescence. In order to distinguish authentic value documents from counterfeits, a check is usually made to establish whether or not the respective value document actually comprises luminescent mottled fibers.

Counterfeits of value documents occur again and again, these also being referred to as composed counterfeit hereinafter. These may arise as a result of a separated part of a value document being joined—usually by adhesive bonding—to a substrate section, for example a suitably shaped piece of paper or film, in such a way that a structure arises which has approximately the dimensions of the value document. A value document may be skillfully divided into two parts, for example, which are then each joined together with a suitable substrate section. This results in two counterfeits of the value document, which may be distinguishable from the authentic value documents only with difficulty, depending on the embodiment of the counterfeit.

Various methods are known for recognizing composed counterfeits, these methods being based e.g. on the recognition of adhesive strips or a printed image offset. With the known methods, however, only some composed counterfeits can be recognized, while other composed counterfeits remain unrecognized.

The present invention is therefore based on the object of providing a sensor and an improved method for verifying a value document regarding the suspected presence of a counterfeit, in particular a composed counterfeit.

This object is achieved by means of the features of the independent claims. Advantageous configurations and developments of the invention are specified in claims which are dependent on said independent claims.

The invention relates to the verification of value documents which comprise a multiplicity of fibers distributed over the value document and having a characteristic optical or magnetic signal. The fibers can be distributed (nonuniformly or uniformly) over one or more sections of the value document or over the entire value document. They can be distributed e.g. in the substrate of the value document or on the surface of the substrate. In particular, the optical and/or magnetic properties or signals of the fibers differ from the optical and/or magnetic properties or signals of the substrate of the value document. The value documents which are verified by the method according to the invention are for example banknotes, checks, tickets, vouchers, etc. In order to verify such value documents, in particular in order to recognize counterfeits, in particular composed counterfeits, the value document to be verified in each case is brought into a capture region of a sensor.

The sensor comprises an image capture device configured to capture a value document image of the value document, preferably of the entire value document. In particular, the image capture device is configured for the spatially resolved detection of optical or magnetic signals of the value document. The value document image shows the two-dimensional distribution of optical or magnetic signals of the value document over the value document, preferably over the entire value document, and contains or shows a characteristic optical or magnetic signal of the fibers. The sensor in particular also comprises a control device configured to control the image capture device in such a way that the latter detects optical or magnetic signals of the value document in a spatially resolved manner.

Furthermore, the sensor comprises an evaluation device configured for evaluating the value document image. The evaluation device is configured to localize the fibers contained in the respective value document image and to ascertain for one or more different locations of the value document image in each case at least one local fiber characteristic value which applies to the respective location and optionally to surroundings of the respective location on the value document image. The evaluation device is additionally configured to classify the value document as suspected counterfeit depending on the at least one local fiber characteristic value, in particular depending on the local fiber characteristic values ascertained for the different locations of the value document image. In the event of automatic processing of the value documents by means of a value document processing apparatus, the suspected counterfeit value document can then be automatically segregated by the value document processing apparatus.

The evaluation device is configured to receive the value document image captured by the image capture device, said image being communicated to the evaluation device (e.g. by a processor or the image capture device). The evaluation device can be arranged in the sensor housing of the sensor or outside the sensor housing. It can also be a central evaluation device of the value document processing apparatus, which evaluates the measurement signals of a plurality of sensors (optionally jointly).

The respective local fiber characteristic value applies individually to the respective location of the value document image or individually to the respective location and the (spatial) surroundings thereof on the value document image. The surroundings of the respective location can concomitantly include the respective location. The surroundings of different locations are not congruent, but can overlap one another. In general, the local fiber characteristic values of different locations on the value document differ from one another. For the respective location and the surroundings thereof in each case exactly one local fiber characteristic value can be ascertained or for the respective location and the surroundings thereof in each case different local fiber characteristic values can also be ascertained and used for classifying the value document.

The respective location for which the at least one local fiber characteristic value is ascertained, and optionally the surroundings of the respective location, corresponds e.g. to a partial image of the value document image or to a grid point, optionally with the surrounding region assigned thereto (as will be explained further below).

By way of example, the local fiber characteristic value is characteristic of the local density of the fibers in the surroundings of the respective location and/or the local distribution of the fibers in the surroundings of the respective location and/or the position of one or more fibers in the surroundings of the respective location and/or the local constitution of the fibers in the surroundings of the respective location. Said constitution can concern in particular the appearance of the fibers (e.g. the shape or size or color or brightness of the fibers) at the respective location and in the surroundings of the respective location or—in the case of magnetic fibers—also the level of the magnetic signal of the fibers at the respective location and in the surroundings of the respective location. By way of example, the local fiber characteristic value used is a representative value, e.g. a mean value, of the local constitution of the fibers at the respective location and in the surroundings of the respective location. Alternatively, the local fiber characteristic value used is the distance from the respective location to the closest fiber, this distance being characteristic of the local position of one or more fibers in the surroundings of the respective location. The local fiber characteristic value used can also be the association of the respective location with an effect region (will be defined further below) defined around the respective fiber.

In preferred exemplary embodiments, the local fiber characteristic value used is a measure of the local density of the fibers. For this purpose, in the respective partial image or surrounding region, the local fiber characteristic value used can be the number of fibers or the fiber density (number of fibers divided by the area of the partial image/surrounding region) or a (e.g. statistic) distance measure—which is characteristic of the distance between the fibers—of the fibers located closest to the respective location or of the fibers in the respective partial image/surrounding region of the respective location, e.g. the mean distance of these fibers of the partial image/surrounding region from the fiber that is the most closely adjacent to the respective fiber.

In other preferred exemplary embodiments, the local fiber characteristic value used is a measure of the local constitution of the fibers at the location and optionally in the surroundings of the respective location, which concerns in particular the shape (e.g. aspect ratio, orientation, winding(s)) or size (e.g. length, width, area) or color or brightness of the fibers at the respective location and optionally in the surroundings of the respective location.

The fibers whose optical and/or magnetic properties differ from the optical and/or magnetic properties of the substrate of the value document are individual thin, elongate objects, e.g. having a length in the range of a few millimeters. In this application, the term fibers does not mean the paper fibers of the paper substrate of a value document. The fibers are produced separately from the substrate material of the value document and are introduced into or applied onto the substrate material of the value document after they have been produced. The fibers are produced e.g. from paper or composed of a material which differs from the substrate material of the value document, e.g. composed of plastic or composed of metal, and the substrate material of the value document being composed of paper. The fibers are for example luminescent fibers distributed in or on the substrate of a non-luminescent value document substrate, or magnetic fibers distributed in or on the substrate of a nonmagnetic value document substrate, or black, gray, or single-color or multicolor fibers distributed in or on the substrate of a light or white value document substrate.

In some value document types, the fibers are distributed substantially uniformly over the respective value document. Deviations from an absolutely uniform distribution may arise as a result of statistical fluctuations during the production of the value document, for instance when fibers are applied to the value documents or when the fibers are introduced into the composition (e.g. into the paper composition or plastic composition) from which the value document substrate is produced. In other value document types, the value documents have only one or a plurality of specific fiber-containing regions, the position of which on the value document is fixedly predefined.

The evaluation device is configured in particular to carry out an image analysis of the value document image in which—on the basis of the signal distribution of the optical or magnetic signals—fibers possibly contained in the value document image are localized. The fibers can be identified by searching for respectively adjacent image points of the value document image whose signal intensity exceeds a threshold, and by checking whether the objects respectively arising from such adjacent image points have the expected shape, in particular thickness and length and optionally shape, of a fiber. The localized fibers can have identical or different constitutions, e.g. identical or different shapes or colors.

For the verification of the value document, the latter can be introduced in static fashion into the capture region of the sensor. The sensor used is then preferably a two-dimensional image sensor that detects the optical or magnetic signals emanating from the value document. Preferably, the value document is transported past the sensor along a transport direction, however, in order to scan the different value document sections successively by means of the sensor. The sensor used is then preferably an optical or magnetic image sensor embodied as a sensor linear array.

In a first variant, the sensor is a magnetic sensor and the image capture device is configured for the spatially resolved detection of magnetic signals of the value document, in particular of the fibers. The value document image is then a magnetic signal image of the value document. Moreover the fibers are magnetic fibers whose magnetic properties differ from the magnetic properties of the substrate of the value document. The characteristic magnetic signal of the fibers is then a magnetic signal of the fibers that differs distinctly from the usually low or vanishingly small magnetic signal of the value document substrate, which is nonmagnetic or not very magnetic. The image capture device is a magnetic signal image capture device configured for the spatially resolved detection of the magnetic signals of the fibers. It comprises in particular a multiplicity of magnetosensitive detector elements and can be e.g. a high-resolution magnetic detector linear array (for verifying a value document that is transported past the sensor) or can comprise magnetosensitive detector elements arranged two-dimensionally.

In a second variant, the sensor is an optical sensor and the image capture device is configured for the spatially resolved detection of optical signals of the value document, in particular of the fibers. Moreover the fibers have optical properties that differ from the optical properties of the substrate of the value document. The image capture device is then an optical image capture device (e.g. an optical image sensor) configured for the spatially resolved detection of optical signals of the fibers, in particular of luminescence or reflection of the fibers. The image capture device comprises a multiplicity of photosensitive elements and is for example an image sensor linear array or a two-dimensional image sensor, e.g. in a CCD- or CMOS-based embodiment. The value document image can be a reflection image or a luminescence image of the value document.

In the case of an optical sensor, an illumination device can be used for illuminating a value document introduced into the capture region of the optical sensor, which illumination device can be part of the sensor. It can be suitable for illuminating the value document or for exciting luminescence of the value document. The value document to be verified is introduced into the capture region of the optical sensor in such a way that it can be illuminated or optically excited by the light from the illumination device and the light emanating from the value document can be detected by the optical image capture device. The light emanating from the value document can be reflection light, i.e. illumination light from the illumination device that is reflected (directionally or nondirectionally) by the value document. Alternatively, the light can be luminescence light which the value document emits as a consequence of the illumination which is suitable for the optical excitation and which is emitted by the illumination device. The term luminescence is understood as an umbrella term encompassing the radiation re-emitted by the value document after (optical or electrical) excitation, e.g. fluorescence or phosphorescence.

In a first embodiment of the second variant, the optical sensor is a reflection sensor and the value document image that the optical image capture device is configured to capture is a reflection image of the value document. The characteristic optical signal of the fibers is then a reflection signal of the fibers. In the reflection image, the fibers appear e.g. black, gray, or colored against a background formed by the value document substrate or other security features of the value document. The background can be dark, light or white, but also structured or multicolored, as long as the reflection signal of the fibers differs distinctly therefrom. In this case, the fibers can be luminescent or nonluminescent, magnetic or nonmagnetic. The reflection sensor optionally comprises an illumination device configured to illuminate the value document with illumination light.

In a second embodiment of the second variant, the fibers are luminescent fibers and the optical sensor is a luminescence sensor. Accordingly, the value document image that the optical image capture device is configured to capture is then a luminescence image of the value document and the characteristic optical signal of the fibers is a luminescence signal of the fibers. The luminescence signal can be a fluorescence or phosphorescence signal. The background of the nonluminescent value document substrate is then usually dark. The luminescence sensor optionally comprises an illumination device configured to illuminate the value document with an excitation light emitted by the illumination device in order to optically excite the luminescent fibers of the value document. Alternatively, however, the luminescence of the fiber can also be excited electrically if the luminescence is electroluminescence. The image capture device of the luminescence sensor is an optical image capture device configured for capturing the luminescence image of the value document.

All of the following explanations relate both to the first and to the second variant (and here both embodiments of the second variant) equally.

The evaluation device can be configured to determine one or more partial images of the value document image, each of which contains a segment of the value document image. The shape of the partial images can be e.g. square, rectangular, round, or any other shape that may be desired. The partial images contain e.g. non-congruent segments of the value document image, which can overlap one another in part or do not overlap. The overlapping of a plurality of partial images increases the probability that one of the partial images used will be precisely in a possibly present counterfeit section of the value document (the position of which is not previously known). The local fiber characteristic value of the counterfeit section then deviates from an expected value more than in the case where the partial image is only partly in the counterfeit section. The relevant counterfeit is therefore discovered more easily in the case of overlapping partial images.

The respective partial image is preferably determined such that the characteristic optical or magnetic signal of a plurality of fibers of the value document is expected in the respective partial image. The evaluation device is configured e.g. to determine in each case the at least one local fiber characteristic value for one or more of the partial images and to classify the value document as suspected counterfeit (or not suspected counterfeit) depending on the at least one local fiber characteristic value of one or more of the partial images. The position or size of the partial images in the value document image can be predetermined or can be chosen dynamically, e.g. depending on the position of the (previously localized) fibers, or depending on the transport position of the value document. The local fiber characteristic value is characteristic of e.g. the local density of the fibers in the respective partial image and/or the local distribution of the fibers in the respective partial image and/or the position of one or more fibers in the respective partial image and/or the local constitution of the fibers in the respective partial image.

In a development of the invention, the evaluation device, for the purpose of evaluating the value document image, is configured to scan the value document image (systematically) point by point using grid points, wherein a local fiber characteristic value is ascertained for each grid point of the value document image, and to classify the value document as suspected counterfeit depending on the local fiber characteristic values ascertained in this case. The grid point can be a single image point of the value document image or a plurality of image points of the value document image that are combined to form a grid point. The grid points have e.g. predefined positions on the respective value document image and are preferably distributed uniformly over the value document. The local fiber characteristic value determined for the respective grid point can apply pointwise to the respective grid point or to a surrounding region around the respective grid point. The surrounding region can also contain the respective grid point. The respective grid point, optionally with the surrounding region assigned thereto, can correspond in each case to a partial image of the value document image.

The local fiber characteristic value ascertained for each grid point of the value document image is e.g. characteristic of the density/the position/the constitution/the distribution/the number/the distance of one or a plurality of fibers closest to the respective grid point. By way of example, a mean local fiber characteristic value over a plurality of grid points can be ascertained and the dispersion of the local fiber characteristic values around this mean value, said dispersion arising when a plurality of grid points are considered, can be used for classifying the value document as suspected counterfeit. If the dispersion is too great, the value document is segregated as suspected counterfeit.

In one development of the invention, the evaluation device, for the purpose of evaluating the value document image, is configured to identify one or more conspicuous grid points which are conspicuous with regard to the local fiber characteristic value ascertained at the respective grid point, and, in particular on the basis of the position of the conspicuous grid points on the value document image, to identify one or more conspicuous regions of the value document image in which conspicuous grid points are situated. The evaluation device then classifies the value document as suspected counterfeit depending on one or more properties of the respective conspicuous region and/or depending on the local fiber characteristic values which were ascertained for the grid points of the respective conspicuous region (for which purpose it is possible to use the local fiber characteristic values of the conspicuous grid points and optionally also of the non-conspicuous grid points which lie in the conspicuous region).

A grid point is categorized as conspicuous e.g. by means of comparing the local fiber characteristic value determined for the respective grid point with an expected value applicable to the respective local fiber characteristic value. In the event of deviation of more than an acceptable fluctuation range, the respective grid point is categorized as conspicuous. The value document can be classified as suspected counterfeit e.g. if at least a minimum proportion of the grid points of a conspicuous region is conspicuous. The value document can alternatively be classified as a suspected counterfeit depending on a mean local fiber characteristic value averaged over all the grid points of the respective conspicuous region. Alternatively, the dispersion of the local fiber characteristic values around this mean value, said dispersion arising when a plurality of surrounding regions around the conspicuous region are considered, can also be used for classifying the value document as suspected counterfeit.

By way of example, the respective partial image/the respective surrounding region is identified as a conspicuous region. Alternatively, the conspicuous region of the value document image can be ascertained only on the basis of the distribution of conspicuous grid points, i.e. dynamically. In particular, the evaluation device, for the purpose of evaluating the value document image, can be configured to determine the distribution of the conspicuous grid points and to ascertain one or more conspicuous regions on the basis thereof. It is also possible to select conspicuous partial images from predefined partial images. Alternatively, conspicuous regions of variable shape and size can also be defined on the basis of the distribution, e.g. by means of an image analysis in which, in each line/column/line section/column section of the value document image, the magnitude of the respective proportion of the line/column/line section/column section that is constituted by conspicuous grid points is ascertained. If this proportion is greater than a reference value, the respective line/column/line section/column section is categorized as conspicuous. The conspicuous region can then be formed from the conspicuous line/column/line section/column sections or grid points, and the value document can be classified as a suspected counterfeit on the basis of the properties of said conspicuous region.

The property/properties of the respective conspicuous region depending on which the value document is classified as suspected counterfeit is/are e.g. the differences in the local fiber characteristic values at the grid points of the conspicuous region of the value document image in comparison with an expected value applicable to the respective local fiber characteristic value and/or the shape of the conspicuous region or the distribution of a plurality of conspicuous regions over the value document image and/or the number of conspicuous regions found in the value document image. The expected value can be predetermined or can have been ascertained on the basis of the local fiber characteristic values of other regions of the value document image or with the mean local fiber characteristic value of the entire value document image.

In some exemplary embodiments, the evaluation device, for the purpose of evaluating the value document image, is configured to ascertain the or at least one of the local fiber characteristic values ascertained for the respective grid point of the value document image for an (areal) surrounding region assigned to the respective grid point. The respective grid point with surrounding region can be one of the abovementioned partial images of the value document image. The surrounding regions can form concurrent partial images during scanning. The surrounding region assigned to the respective grid point preferably lies at least in the vicinity of the respective grid point, e.g. directly next to or around the respective grid point, such that the respective grid point lies in the respective surrounding region. The respective grid point lies e.g. at the edge of or within the surrounding region assigned to it. The size of the surrounding region can be fixedly predefined or else chosen depending on an expected density value of the fibers. The respective local fiber characteristic value is ascertained in the surrounding region around the respective grid point. The surrounding regions around adjacent grid points can overlap or not overlap one another.

In other exemplary embodiments, the evaluation device, for the purpose of evaluating the value document image, is configured to ascertain the or one of the local fiber characteristic values, ascertained for each grid point of the value document image, pointwise for the respective grid point. In this case, the local fiber characteristic value is ascertained only at the respective grid point itself. Accordingly, no surrounding region around the grid point is required or defined for determining the respective local fiber characteristic value. By way of example, the local fiber characteristic value used can be the local distance from the respective grid point to the closest fiber or the association of the respective grid point with one or more effect regions of the fibers (see below).

Preferably, the evaluation device is configured to determine each of the partial images of the value document image in such a way that the characteristic optical or magnetic signal of a minimum number of fibers is expected in the respective partial image. In particular, in the sensor for one or more value document types it is possible to provide in each case an expected density value for the area density of fibers for the respective value document type. In particular, this is preferred for such value document types which feature value documents having the fibers distributed substantially uniformly (but randomly) over the respective value document, distributed substantially uniformly either over the entire value document or at least over a section of the value document in which the partial images are determined. The evaluation device, for the purpose of determining the at least one partial image of the value document image, can be configured, on the basis of the expected density value of the fibers of the value document type to be verified, to choose the area content of each partial image of the value document image with a magnitude at least such that—in view of a random statistical distribution of the fibers over the value document—the respective partial image is expected to contain the characteristic optical or magnetic signal from at least the minimum number of fibers.

By way of example, the evaluation device can be configured, when determining the at least one partial image of the value document image, to determine the partial images in such a way that the area content F thereof is in each case at least the minimum number M divided by the expected density value DE: F>=M/DE. In the case of a relatively low expected density value DE of the fibers, the sensor therefore defines partial images having a relatively large area content. This ensures that the expected value for the number of fibers in the respective partial image is large enough to enable a selective verification. This is because a fiber number of zero in the case of an authentic value document equipped with fibers is then very improbable. The probability of mistaken classification of an authentic value document as a composed counterfeit drops as the expected value for the number of fibers increases.

In the case of a relatively large expected value, the probability that—in the case of an authentic value document having a uniform distribution of the fibers—a very small number (e.g. zero) of fibers will occur in the partial image to be verified becomes lower. Otherwise, if only few fibers are expected in a partial image, it might happen even in the case of an authentic value document that by chance no fiber is found in the partial image being verified. In order to avoid a situation where authentic value documents—owing to an excessively small number of fibers found in a partial image—are inadvertently classified as suspected counterfeit, it is therefore advantageous to define partial images which have a relatively large expected value for the number of fibers and/or to determine for a value document two or more partial images which cover the largest possible area proportion of the value document.

Preferably, the evaluation device is configured to determine at least two partial images of the value document image (which are arranged e.g. next to one another on the value document image), in particular at least two such partial images of the value document image which together preferably cover at least 50% of the area of a value document side of the value document, in particular at least 75% of the area of a value document side of the value document. The partial images can be distributed nonuniformly over the value document or can be arranged uniformly, e.g. in rows and/or in columns, on the value document. In particular, the partial images can be arranged in a grid composed of at least two rows and/or at least two columns on the value document. The evaluation device can also be configured, when determining the partial images of the value document image, to divide the value document image among a plurality of partial images substantially over an extensive area, e.g. independently of the value document type.

In one development of the invention, the sensor is configured for verifying value documents of one or more specific value document types, the value documents of which comprise in each case at least one disturbing (e.g. optical or magnetic) security element which disturbs or adversely affects the capture of the characteristic optical or magnetic signal of the fibers. In order to verify such value documents, the evaluation device of the sensor is configured to classify the value documents of the specific value document type as suspected counterfeit depending on the at least one local fiber characteristic value of only one or a plurality of such locations of the value document image at which the capture of the optical or magnetic signal of the fibers is not adversely affected by the specific (e.g. optical or magnetic) security element. Not adversely affected is understood to mean that the optical or magnetic signals of the fibers are not influenced by the specific security elements or at most are influenced thereby only to an extent such that the at least one local fiber characteristic value of the respective location can still be determined—despite the specific security element possibly present there. This rules out or avoids such locations of the value document image at which physical shielding of the optical or magnetic signals of the fibers e.g. by absorbent or reflective security elements occurs or at which disturbing superposition with optical or magnetic signals of the security elements occurs.

Preferably, the only locations of the value document image which are selected or the only locations whose local fiber characteristic value is evaluated are those which lie outside a disturbing security element.

For example, in advance of the value document verification (e.g. in the course of sensor adaptation), the evaluation device of the sensor acquires information about the positions of disturbing (optical or magnetic) security elements of the value documents to be verified, optionally for a plurality of value document types. The evaluation device can be configured, on the basis of the information about the position of one or more disturbing security elements, to determine the locations or partial images of the respective value document image that are to be evaluated during the evaluation process in such a way that the optical or magnetic signals of the fibers at the respective location or in the respective partial image are not adversely affected by a disturbing (e.g. optical or magnetic) security element. In particular, the position (and optionally also the shape or size) of the partial images on the value document can be determined in such a way that the partial images do not overlap any disturbing security element.

In the case of an optical sensor, determining the locations or partial images to be evaluated involves skipping or omitting in particular such regions of the value document image which contain fluorescent or absorbent optical security elements, such as e.g. patches, fluorescence elements or darkly printed value document regions. For example, the locations or partial images to be evaluated are preferably positioned in white and in lightly printed regions. In the case of a magnetic sensor, determining the locations or partial images to be evaluated involves skipping or omitting in particular such regions of the value document image which contain magnetic security elements with the very large magnetic signal, e.g. a magnetic security thread or a magnetic printed region, the magnetic signal of which is of the order of magnitude of the magnetic signal of the magnetic fibers. In this case, these disturbing magnetic security elements can lie on the value document side facing the sensor or on the value document side facing away from the sensor (the magnetic signal of which side can nevertheless cause disturbance).

The evaluation device of the sensor can also have information about the transport position of the value document to be verified in each case and/or information about the value document type (e.g. currency or denomination) of the value document to be verified in each case. The transport position can be one of 4 possible transport positions: front side of the value document top/bottom, distinguished edge of the value document leading/trailing. The evaluation device can be configured, on the basis of the information about the transport position and/or on the basis of the information about the value document type of the value document to be verified in each case, to determine for evaluation purposes only such locations or partial images of the value document image at which the capture of the optical or magnetic signal of the fibers is not adversely affected by one of the disturbing security elements. The value document to be verified in each case is then classified as suspected counterfeit by the evaluation device depending on the local fiber characteristic values of only the locations or partial images determined for evaluation purposes, i.e. depending on local fiber characteristic value of only such locations or partial images at which the capture of the optical or magnetic signal of the fibers is not adversely affected by a disturbing security element.

By way of example, in advance of the value document verification (e.g. in the course of sensor adaptation) for one or more value document types, the evaluation device of the sensor acquires information about the position of one or more disturbing (e.g. optical or magnetic) security elements of the respective value document type depending on the value document type of the value documents and/or depending on the transport position of the value documents. The evaluation device can be configured e.g. —on the basis of the information about the value document type of the value document to be verified in each case and using the information about the position of the disturbing (optical or magnetic) security element(s) of the respective value document type depending on the value document type—to determine for evaluation purposes only such locations or partial images of the value document to be verified in each case at which the capture of the optical or magnetic signal of the fibers is not adversely affected by a disturbing security element. Additionally or alternatively, the evaluation device can be configured—on the basis of the information about the transport position of the value document to be verified in each case and using the information about the position of the disturbing (optical or magnetic) security element(s) of the respective value document type depending on the transport position of the value documents—to determine for evaluation purposes only such locations or partial images of the value document to be verified in each case at which the capture of the optical or magnetic signal of the fibers is not adversely affected by a disturbing security element.

The information about the transport position and/or value document type of the value document to be verified in each case can be provided in the sensor itself (e.g. in cases in which it is invariable), e.g. can be stored in a data memory of the sensor and can be communicated to the evaluation device, or can be fed to the evaluation device from outside the sensor, e.g. from another sensor of the value document processing apparatus, which has recognized the transport position and/or the value document type of the value document to be verified in each case, or from another device of the value document processing apparatus, which has stored the transport position currently set at the value document processing apparatus and/or the value document type. The information concerning the position of the specific security elements of the value document depending on the transport position and/or depending on the value document type of the value document can also be provided in the sensor itself, e.g. can be stored in a data memory of the sensor that can be accessed by the evaluation device, or can be fed to the evaluation device from outside the sensor, e.g. from another sensor or from another device of the value document processing apparatus.

In some exemplary embodiments, the evaluation device, for the purpose of evaluating the value document image, is configured to assign a respective (areal) effect region to the localized fibers of the value document image (to all or a subset of the fibers of the value document image or to each fiber of the respective partial image/of the respective surrounding region around the respective grid point). The respective fiber preferably lies within (e.g. in the center) of the effect region assigned to it. For evaluation purposes, for the respective locations of the value document image (e.g. for a plurality of different partial images or surrounding regions around grid points), the evaluation device analyzes in each case locally the effect regions of the fibers localized at the respective location and optionally in the surroundings thereof, e.g. the effect regions of the fibers present in the respective partial image or in the respective surrounding region around the respective grid point. For example, in this case, the effect regions are analyzed locally with regard to the area that is covered or not covered by them or with regard to an overlap of adjacent effect regions. The evaluation device ascertains the respective local fiber characteristic value of the respective location (e.g. partial image or surrounding region) on the basis of the local analysis of the (locally present) effect regions lying at the respective location and optionally in the surroundings thereof. For example, the local fiber characteristic value is determined depending on the overlap/the distribution of the effect regions/the position of the effect regions/the area of the effect regions.

The size and/or shape of the effect regions can be identical for each of the localized fibers of the value document image. However, the size and/or shape can also be different depending on the region on the value document. For example, the effect regions can each have the shape of a circle, an oval or a rectangle with the respective fiber in the center. Alternatively, the shape and/or size can also be chosen depending on the fiber shape, e.g. in the form of a tubelike structure around the respective fiber. The effect regions are preferably defined in such a way that they have a smaller area than the partial images or surrounding regions. Specific local fiber characteristic values can then be determined more accurately. However, the partial images or surrounding regions can also be smaller than the effect regions, e.g. in the case of local fiber characteristic values which are determined only at the respective grid point, e.g. the local distance from the respective grid point to the nearest fiber, or association of the respective grid point with at least one effect region of a fiber (yes/no).

In particular, the evaluation device, for the purpose of evaluating the value document image, is configured to choose the size of the effect regions depending on an expected density value indicating the (optionally locally) expected area density of the fibers, in particular inversely proportionally to the expected density value. The expected density value can be identical at each location of the value document image if the fibers are distributed uniformly over the value document, or can apply only to the respective partial image or surrounding region. Therefore, effect regions defined in the case of a large expected density value are smaller than those defined in the case of a small expected density value. As a result, conspicuous regions of the value document image which contain too few or too many fibers can be found better by means of analysis of the effect regions even in the case of different value document types (with different expected density value).

In one exemplary embodiment, the evaluation device, for the purpose of evaluating the value document image, is configured, for the entire value document image or for one or more partial images in each case or for at least one or more surrounding regions around grid points in each case, to identify coverage regions which belong to the effect region of at least one of the fibers of the value document image or of the respective partial image or of the respective surrounding region and/or to identify free regions which do not belong to an effect region of at least one of the fibers of the value document image or of the respective partial image or of the respective surrounding region and/or to identify overlap regions in which the effect regions of at least two (adjacent) fibers of the value document image or of the respective partial image or of the respective surrounding region overlap, and to identify one or more conspicuous regions (e.g. partial image, surrounding region) of the value document image which are conspicuous with regard to their coverage regions/free regions/overlap regions (e.g. in regard to their area/area proportion), and to classify the value document as suspected counterfeit depending on the properties of the coverage regions and/or the free regions and/or the overlap regions in/at one or more conspicuous regions of the value document image.

The property/properties depending on which the value document is classified as suspected counterfeit are e.g. the area content and/or the area proportion of the coverage regions and/or of the free regions and/or of the overlap regions in/at one or more conspicuous regions of the value document image and/or the shape of the conspicuous region or the distribution of a plurality of conspicuous regions over the value document image and/or the number of conspicuous regions found in the value document image. A region/a partial image/a surrounding region can also be categorized as conspicuous depending on the area content of the largest free region and/or overlap region found therein. A region is conspicuous e.g. if the area or the area proportion of the coverage regions/free regions/overlap regions in the respective conspicuous region is greater than expected. This can be determined by comparison with a predetermined reference value for the area/the area proportion or by comparison with other regions (partial images, surrounding regions) or with the mean area proportion of the coverage regions/free regions/overlap regions in the entire value document image.

In one development of the invention, the value document image captured by the image capture device is a first value document image, which is captured from a first value document side (front or rear side) of a value document to be verified, and the evaluation device additionally has a second value document image, which was captured from the second side of the same value document to be verified (rear or front side), said second side being opposite the first side. The evaluation device is then configured to determine in each case at least one local fiber characteristic value for at least one first partial image of the first value document image and for at least one second partial image of the second value document image, wherein preferably mutually corresponding local fiber characteristic values are determined for the first and second partial images, which values are comparable with one another. By way of example, the local fiber characteristic value of the first and second partial images is in each case characteristic of the local density of the fibers in the respective first or second partial image or the local distribution of the fibers in the respective first or second partial image or the position of one or more fibers in the respective first or second partial image or the local constitution of the fibers in the respective first or second partial image. The value document is then classified as suspected counterfeit, in particular with regard to the presence of a composed counterfeit, depending on the local fiber characteristic value of the at least one first partial image and depending on the local fiber characteristic value of the at least one second partial image. The first and second partial images can be positioned in the same section or in different sections of the respective value document.

The local fiber characteristic values of the first and second partial images can be checked separately from one another (e.g. can each be compared with an expected value) or they can be combined with one another or compared with one another. In the case of combination, e.g. the mean value of the fiber density of the first partial image and the second partial image (optionally corresponding thereto) is determined or the numbers of fibers in the first and second partial images are added together, and the value document is classified as suspected counterfeit depending on the mean fiber density or depending on the sum of fibers in the first partial image and second partial image (optionally corresponding thereto). The evaluation device can also compare the local fiber characteristic values of the first partial image and the second partial image (optionally corresponding thereto) with one another (e.g. the density or the mean fiber spacing) and classify the value document as suspected counterfeit depending on the comparison result, e.g. in the case of deviations from one another which are greater than an acceptable fluctuation range. Counterfeits that are provided with fibers only on one side can be discovered as a result.

The choice of the partial images or the area of the possible partial images of a value document side can be restricted by other security elements or dark printed regions of the value document. The evaluation both of at least one partial image of the front side and of at least one partial image of the rear side results in the verification of a larger value document area than in the case where the value document is verified only on one side, and the verification becomes more reliable as a result. What is achieved, therefore, by the evaluation of partial images of the front and rear sides is that even such value documents for which only small partial images are possible or which have relatively few fibers can be verified reliably.

In one particularly advantageous variant of evaluation on both sides, the evaluation device is configured to determine, with respect to the at least one first partial image of the first value document image, a corresponding second partial image of the second value document image, which is a segment of the second value document image, wherein the first partial image and the corresponding second partial image contain the optical or magnetic signals of the front and rear sides of the same value document section of the same value document. The evaluation device is configured e.g. to determine the corresponding image points of the second value document image with respect to the image points of the first value document image. In order to find the second partial image (e.g. of the rear side) corresponding to the first partial image (e.g. of the front side), mirroring of the first or second partial image (front or rear side image) and possibly slight rotation and/or displacement of the images relative to one another may be necessary.

The evaluation device is additionally configured to determine in each case at least one local fiber characteristic value for one or more pairs comprising first partial image and second partial image corresponding thereto, wherein preferably mutually corresponding local fiber characteristic values are determined for the first and second partial images, which values are comparable with one another, and to classify the value document as suspected counterfeit, e.g. with regard to the presence of a composed counterfeit, depending on the local fiber characteristic values of the first partial image and of the second partial image corresponding to the first partial image. The local fiber characteristic values of the first partial image and the second partial image corresponding thereto can be checked separately from one another or they can be combined with one another or compared with one another (examples, see above).

An even more accurate value document verification is achieved by means of the evaluation of the mutually corresponding partial images of the same value document section of the front and rear sides. Since, after all, the two corresponding partial images show the same value document section (e.g. front and rear sides of the same piece of paper), this evaluation on both sides therefore does not entail a mere enlargement of the verified area, but rather—owing to the spatial correspondence of the partial images on the value document—is more meaningful than jointly evaluating two arbitrary partial images of the same value document. This is because, for two arbitrary partial images of the same value document, in the case of a composed counterfeit, it should be expected that said partial images do not both lie in the counterfeit section or do not both lie in the authentic section, rather in many cases one of the partial images will lie in the counterfeit section and one in the authentic section of the composed counterfeit. A combined local fiber characteristic value (e.g. mean value) of such partial images would therefore be closer to the expected value of the authentic value document than in the case of partial images corresponding to one another.

However, if the two corresponding partial images of the front and rear sides which contain exactly the same value document section are evaluated, it is certain that, if one of these partial images (e.g. the front side partial image) lies in the counterfeit section of a composed counterfeit, the other partial image (the rear side partial image) corresponding thereto then also lies in the counterfeit section of this composed counterfeit. There is therefore greater probability of the two corresponding partial images both lying in the counterfeit part of a composed counterfeit. A combined local fiber characteristic value of the two corresponding will then deviate distinctly from the expected value. As a result, a greatly improved selectivity for the recognition of counterfeits is achieved by means of the same value document section being evaluated on both sides.

The respective pair comprising first partial image and corresponding second partial image can be categorized as suspicious depending on the two local fiber characteristic values and the value document can be classified as suspected counterfeit depending on the pairs comprising first partial image and corresponding second partial image of the respective value document that have been categorized as suspected counterfeit, in particular depending on the number of pairs comprising first partial image and corresponding second partial image of the respective value document that have been categorized as suspected counterfeit, e.g. if the number of such pairs for the same value document is at least 1 or 2.

The second value document image can be captured with the aid of the same image capture device, wherein the first and second value document images are captured successively, for example, if the value document is transported past the optical sensor once again in a transport position in which the value document has been turned over. Alternatively, the second value document image can also be captured (optionally simultaneously with the first value document image) with the aid of another image capture device arranged e.g. on the opposite side to the image capture device mentioned above.

In one development of the invention, the evaluation device is configured, for one or more locations of the value document image (partial images or of the grid points or the surrounding regions thereof), to compare in each case the local fiber characteristic value with a (fiber-related) expected value E. Depending on the result of this comparison obtained for one or more locations of the value document image, the value document is then classified as suspected counterfeit by the evaluation device. By way of example, the evaluation device is configured to classify the value document as suspected counterfeit depending on a difference established during the comparison between the respective local fiber characteristic value of the respective location and the expected value determined for the respective location. The expected value can be different for different locations (partial images or the grid points or the surrounding regions thereof) of the value document image.

For example, the evaluation device determines those locations (e.g. partial images or grid points or the surrounding regions thereof) whose local fiber characteristic value deviates from the respective expected value (e.g. by more than an acceptable fluctuation range). The acceptable fluctuation range is preferably at least 20%, particularly preferably at least 40%, of the respective expected value. Moreover the value document is classified as suspected counterfeit depending on the number and/or position and/or distribution of those locations on the value document image (partial images or grid points or the surrounding regions thereof) whose local fiber characteristic value deviates from the expected value (by more than the acceptable fluctuation range). In particular, a spatial arrangement of the locations (partial images or grid points or the surrounding regions thereof) deviating from the expected value can be compared with a target arrangement known for the respective value document, and the value document can be classified as suspected counterfeit depending on the comparison of the spatial arrangement of the locations deviating from the expected value with the target arrangement.

The expected value used can be e.g. the expected value for the number of fibers, indicating how many fibers should be expected for the respective location if the value document to be verified is an authentic value document of the respective value document type, or the expected density value indicating the fiber density to be expected in the respective partial image. The expected value can be a natural number, a positive real number or zero. Different expected values can be used for fibers having different constitutions, e.g. fibers of different colors.

If the expected value for the number of fibers or the fiber density is greater than zero, it is also possible—as an alternative to a quantitative determination of the difference with respect to the expected value—just to check whether the number of fibers or the fiber density in the respective partial image is equal to zero (or is greater than zero). This is because for establishing a suspected counterfeit, it may suffice for the number of fibers or the fiber density to be equal to zero, even though the expected value therefor is greater than zero. The magnitude of the difference in relation to the respective expected value is not important here. By way of example, the evaluation device, for the purpose of verifying a value document whose fibers are distributed (nonuniformly or substantially uniformly) over the (entire) value document (i.e. in the case of which the expected value for the number of fibers or the fiber density is greater than zero at all points), can be configured to classify the respective value document as suspected counterfeit if the number of fibers for at least a minimum number of partial images is zero, where the minimum number is >0.

The expected value can be predefined for the respective value document or for the respective location, e.g. can have already been defined before the value document verification, in particular depending on the value document type, wherein generally different expected values are predefined or defined for different value document types. Alternatively, the expected value can be ascertained only in the course of the value document verification, e.g. on the basis of the local fiber characteristic values which were determined for a plurality of locations of the respective value document image. In the case of a predefined expected value, the latter can be stored in the evaluation device of the sensor, e.g. in a data memory of the evaluation device. However, the predefined expected value can also be stored externally, e.g. in the value document processing apparatus, and be communicated from there to the evaluation device.

As an alternative or in addition to the verification on the basis of a predefined expected value, the evaluation device can also be configured to determine the expected value with which the local fiber characteristic value of at least one location (partial image or grid point or the surrounding region thereof) is compared on the basis of the local fiber characteristic values which are found for one or more other locations (partial images or grid points or the surrounding regions thereof) of the same value document image. It is thus possible to carry out a relative verification of the local fiber characteristic values of at least two different locations (partial images or grid points or the surrounding regions thereof) of the same value document image. This is advantageous in particular for verifying a value document whose fibers are distributed substantially uniformly over the (entire) value document. For them there is no need for individual predefined expected values to be stored, for instance for newly released value documents. For example, the average local fiber characteristic value of a plurality of other locations of the same value document image can be used as the expected value.

In particular, the evaluation device can be configured to carry out a relative evaluation of the partial images of the same value document regarding the local fiber characteristic values determined in the partial images. In this case, the local fiber characteristic value of one partial image can be compared with the local fiber characteristic value of one or more other partial images of the same value document and the value document can be classified as suspected counterfeit depending on the result of the comparison, e.g. in the event of the local fiber characteristic values of different partial images of the same value document deviating greatly from one another. For example, the evaluation device can be configured to calculate the expected value with which the local fiber characteristic value of at least one of the partial images is compared on the basis of the local fiber characteristic value found at/in one or more other locations/partial images of the same value document. For example, on the basis of one or more of the partial images of the same value document, the evaluation device can determine a mean area density of fibers for this value document and use it as an expected density value. By way of example, the ratio of the local fiber characteristic values determined for different locations/partial images can also be formed and the banknote can be classified as suspected counterfeit depending on this ratio.

The evaluation device can carry out a step-by-step categorization of the individual locations to be examined (partial images or grid points or the surrounding regions thereof) of a value document as suspected counterfeit or not suspected counterfeit. For example, the evaluation device, for the purpose of evaluating the value document image, can be configured to categorize the respective location as suspicious depending on the fiber characteristic value applicable to these locations, e.g. if it differs significantly from the expected value, e.g. by more than a threshold value. Otherwise, the respective location is categorized as not suspicious. The evaluation device then classifies the respective value document as suspected counterfeit (or as not suspected counterfeit) depending on the number of locations categorized as suspicious in the case of the respective value document. In particular, the evaluation device, for the purpose of evaluating the value document image, can be configured to classify the respective value document as suspected counterfeit if the number V of locations (partial images or grid points or the surrounding regions thereof) classified as suspicious in the case of the respective value document reaches or exceeds a minimum number P, i.e. if V>P, where the minimum number is P>0 and is preferably 1 or 2, i.e. the value document is classified as suspected counterfeit in the case of at least one or in the case of at least two locations classified as suspicious.

The acceptable fluctuation range S can be determined from the expected value E, e.g. can be predefined proportionally to the latter. In order to determine an acceptable fluctuation range S, however, before the value document verification—for a multiplicity (e.g. 100) of authentic value documents of the respective value document type—it is also possible to determine the local fiber characteristic value for at least one fixedly predefined location of the respective value document. By averaging these local fiber characteristic values of the multiplicity of value documents, it is possible to determine a mean local fiber characteristic value for the respective value document type and optionally for the respective location, which is then used as the expected value during the verification of the value documents of this value document type. The authentic value documents contained in the multiplicity need not be associated with the same denomination, but rather need only nominally have the same fiber distribution, e.g. be produced from the same fiber-containing substrate. From the local fiber characteristic values determined in each case for the multiplicity of authentic value documents of the respective value document type, additionally or alternatively it is also possible to determine the standard deviation s of the local fiber characteristic value of the respective value document type and optionally of the respective location. The acceptable fluctuation range S for the respective value document type can then be chosen depending on the standard deviation s of the local fiber characteristic value. In particular, a value amounting to at least double, preferably at least quadruple, the standard deviation s can be defined for the acceptable fluctuation range.

In one development of the invention, for one or more value document types in each case the expected value at the respective location of the value document image (e.g. partial image or grid point or the surrounding region thereof) is provided in the sensor. Moreover the evaluation device has information about the value document type of the value document to be verified in each case. The evaluation device can be configured—on the basis of the value document type of the value document to be verified in each case and using the expected value, provided for one or more value document types, for the local fiber characteristic value at the respective location—to determine the expected value for the local fiber characteristic value at the respective location of the value document to be verified in each case, which is expected at the respective location for the value document type of the value document to be verified. The information about the value document type of the value document to be verified can be provided in the sensor itself, e.g. can be stored in a data memory of the sensor that can be accessed by the evaluation device, or it can be fed to the evaluation device from outside the sensor, e.g. from another sensor or from the value document processing apparatus. The information about the value document type of the value document to be verified can be identical for a plurality of value documents to be verified in succession, e.g. if a stack of value documents of the same value document type is verified. However, the information about the value document type can also vary from one value document to be verified to the next and can be communicated individually for each of the value documents, i.e. dynamically, to the sensor according to the invention from the other sensor that determines the value document type.

If the evaluation device has information about the value document type of the value document to be verified, it can determine those locations (partial images or grid points or the surrounding regions thereof) of the value document image for which the respective local fiber characteristic value is determined depending on the value document type of the value document to be verified. For example, the locations can be determined depending on the value document type in a targeted manner in an unprinted region or in weakly printed regions of the value document. In particular, a plurality of locations are fixedly predefined in the evaluation device and the evaluation device determines specific locations for evaluation purposes from these fixedly predefined locations depending on the value document type of the value document to be verified. The locations can be chosen e.g. such that the unprinted/weakly printed region of the respective value document is utilized over the largest possible area. The value document is then classified as suspected counterfeit only depending on the local fiber characteristic values of these locations, while other locations, not intended for evaluation purposes, are disregarded. In particular, the position and/or the area content and/or the shape of the partial images can be chosen depending on the value document type of the value document to be verified. The position and/or shape and/or the area content of the partial images can also be identical for a plurality of value document types, e.g. for a plurality of denominations of the same currency.

In order to determine the position of the locations to be evaluated on the value document image, dynamic information about the transport position of the respective value document can be used, e.g. in order to find the unprinted or weakly printed region of the value document in a targeted manner. However, if the transport position of the value documents is fixedly predefined (as is the case for some value document processing apparatuses), the position of the unprinted or weakly printed region is previously known and dynamic information about the transport position of the respective value document is not required to determine the position of the locations.

Particularly for verifying value documents whose fibers are distributed substantially uniformly over the (entire) value document, the sensor can have in each case information about the mean number or mean area density of fibers for one or more value document types. This information can be different for different value document types. Moreover the evaluation device can be configured, on the basis of the information about the value document type of the value document to be verified, to determine or choose the mean number or mean area density of fibers for the value document to be verified in each case and to define the area content of the partial images of the value document to be verified depending on the mean number or depending on the mean area density of fibers. For example, the area content, the mean number or the mean area density of fibers can be determined with a magnitude such that a minimum number of fibers are expected in the respective partial image. Partial images with a relatively small area content are sufficient in the case of high area density, whereas partial images with a relatively large area content are necessary in the case of low area density. The information about the mean number of fibers or the mean area density of the fibers on the value document, the evaluation device having this information, can be provided in the sensor or in the evaluation device itself or can be communicated there from the value document processing apparatus.

In one development of the invention, the sensor is configured to acquire individual fingerprint data of the respective value document, such as are usable for tracking of value documents, and optionally also to be used itself for the tracking of value documents. Tracking of value documents, in particular of counterfeit or suspected counterfeit value documents, is carried out for example in order to ascertain processing information of the respective value document which can give an indication of the origin or the depositor of the respective (e.g. counterfeit or suspected counterfeit) value document.

The sensor, in particular the evaluation device of the sensor, can be configured to determine individual fingerprint data of the respective value document on the basis of one or more properties of the fibers localized in the value document image (e.g. concerning their position(s), distance(s), shape(s) or size(s) or color(s) or brightness(es)), and/or on the basis of one or more of the local fiber characteristic values of the respective value document which it has ascertained for the different location(s) of the value document image (and optionally the respective surroundings thereof). These individual fingerprint data are unique to the respective value document and generally different for different value documents of the same value document type. The sensor, e.g. its evaluation device or another device of the sensor, can be configured to assign the individual fingerprint data of the respective value document to processing data of the respective value document (e.g. concerning the origin of the value document and/or the denomination of the value document and/or the time and optionally the location of the value document verification carried out by the sensor) and to store them together with the processing data of the respective value document, e.g. in a list for a plurality of value documents, in each case in a manner assigned to one another, and optionally to output them. The processing data of the respective value document can have been at least partly themselves ascertained by the sensor or made available to the sensor from outside.

The individual fingerprint data of the respective value document concern e.g. the number and/or the positions and/or the color locus/loci and/or the size(s) and/or the local densities and/or the fluorescence or phosphorescence properties of the fibers, of the value document image in its entirety or of the respective location(s) of the value document image and optionally its/their respective surroundings, e.g. of one or more partial images of the value document image or of one or more grid points with surrounding region. The individual fingerprint data can comprise for example a vector whose coordinates are formed by the positions of all fibers of the value document image. Alternatively, the individual fingerprint data can also comprise a vector whose different coordinates are given by the local fiber characteristic values, e.g. the local fiber densities, of the different locations and optionally the surroundings thereof on the value document image (e.g. of the partial images or of the grid points with surrounding region). However, the different coordinates of the vector can also be formed by various local fiber characteristic values of one or more locations. Instead of a vector, however, the individual fingerprint data used can also be merely an individual local fiber characteristic value or an individual numerical value for the respective property of the fibers, e.g. the mean value of the respective property (e.g. color locus, size, distances) of all the fibers localized in the value document image.

In order itself to be able to be used for tracking, the sensor can have an operating mode (different than the normal verification mode) for tracking (authentic, counterfeit or suspected counterfeit) value documents, in which operating mode the evaluation device is configured to ascertain the individual fingerprint data of a value document intended for tracking, the sensor recording a value document image of said value document, for instance on the basis of the properties of the fibers localized in the value document image of the value document intended for tracking and/or on the basis of one or more local fiber characteristic values of the value document intended for tracking. For the tracking, the sensor has a list available in which a plurality of individual fingerprint data of (counterfeit/suspected counterfeit) value documents are assigned in each case processing information, e.g. about the origin of the respective value document and/or about the denomination and/or about the time and optionally the location of the value document verification. The list can have been generated at least partly by the sensor itself or it can have been fed to the sensor from outside. On the basis of the individual fingerprint data of the value document intended for tracking, the sensor, in particular by looking up in the list, can ascertain processing data of the value document intended for tracking, in particular regarding the origin/the denomination/the time/the location of the value document verification of the value document intended for tracking, and can output them as the result of the tracking.

The invention also relates to a value document processing apparatus comprising the sensor described and a transport device, which introduces the respective value document into the capture region of the sensor. Alternatively, however, the value document can also be manually introduced into the capture region of the sensor.

The invention also relates to a method—corresponding to the explanations above—for verifying a value document, in particular with the aid of the sensor described, wherein the value document has a multiplicity of fibers distributed over the value document. In the method, a value document is introduced into the capture region of a sensor, and a value document image of the value document is captured with the aid of an image capture device of the sensor, wherein the value document image contains a characteristic optical or magnetic signal of the fibers. For the purpose of evaluating the value document image, an evaluation device of the sensor is configured to localize the fibers contained in the respective value document image, and to ascertain for one or more different locations of the value document image in each case at least one local fiber characteristic value which applies to the respective location and optionally to surroundings of the respective location on the value document image. The evaluation device is additionally configured to classify the value document as suspected counterfeit depending on the local fiber characteristic value(s) ascertained for the location/the different locations of the value document image.

For the purpose of verifying a value document having luminescent fibers distributed over the value document, the value document is introduced into the capture region of the optical sensor and is illuminated there with the excitation light emitted by an illumination device of the sensor in order to optically excite the luminescent fibers of the value document, or is correspondingly electrically excited there. With the aid of the image capture device of the sensor, a luminescence image of the value document is then captured, the luminescence image containing the luminescence of the luminescent fibers. The evaluation device of the optical sensor then carries out the abovementioned evaluation of the luminescence image.

The invention is described by way of example below with reference to figures, in which:

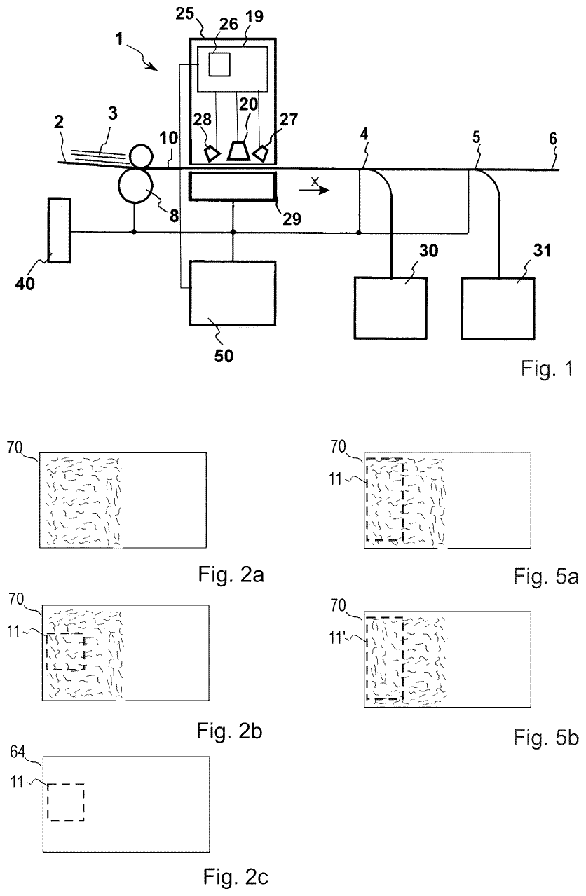

FIG. 1 shows a schematic diagram regarding the setup of a value document processing apparatus comprising an optical sensor for verifying the value documents,

FIGS. 2a-c show a fiber distribution and a possible partial image in the case of an authentic banknote (FIGS. 2a,b) and an associated counterfeit (FIG. 2c),

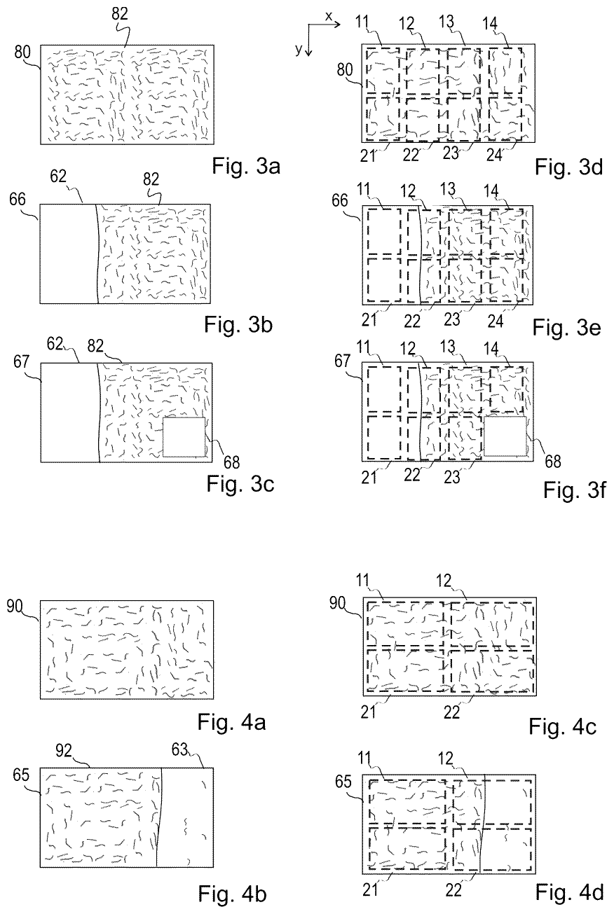

FIGS. 3a-c show a fiber distribution and a grid of predefined partial images in the case of an authentic banknote (FIGS. 3a, 3d) and in the case of an associated counterfeit (FIGS. 3b, 3c, 3e, 3f),

FIGS. 4a-c show a fiber distribution and a grid of predefined partial images in the case of an authentic banknote (FIGS. 4a, 4c) and in the case of an associated counterfeit (FIGS. 4b, 4d),

FIGS. 5a-b show a fiber distribution and mutually corresponding partial images of both opposite sides of an authentic banknote, and

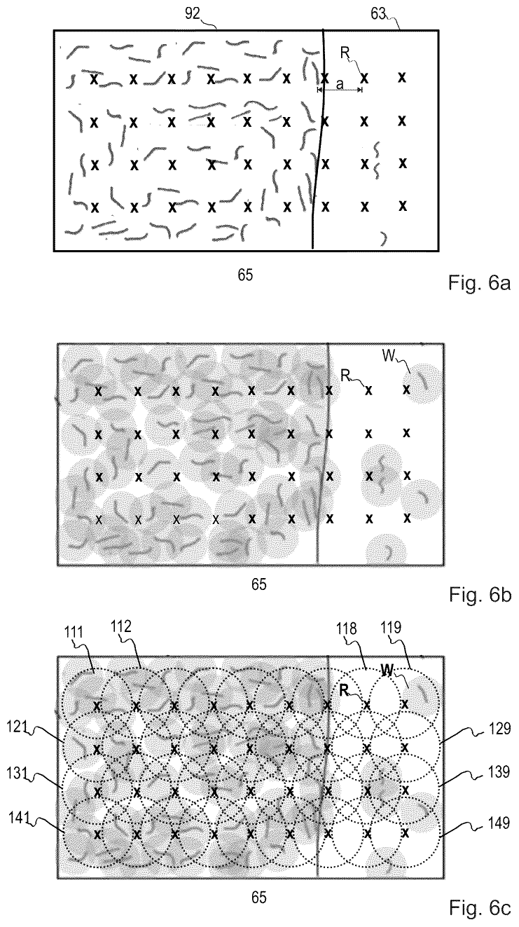

FIGS. 6a-c show a luminescence image which is scanned systematically in a grid of grid points (FIG. 6a), in the case of which an effect region is assigned to each localized fiber (FIG. 6b), in the case of which a surrounding region around each grid point is defined (FIG. 6c).

In the exemplary embodiments, a banknote having luminescent (e.g. fluorescent or phosphorescent) fibers is considered as value document to be verified, and an optical sensor that records and evaluates a luminescence image of the banknote is considered. However, the invention equally relates to the verification of banknotes having reflective or magnetic fibers or the verification of other value documents having luminescent, reflective or magnetic fibers, wherein a magnetic sensor is used for verification purposes in regard to magnetic fibers, which correspondingly records and correspondingly evaluates a magnetic signal image of the value document.

FIG. 1 shows by way of example the schematic setup of a value document processing apparatus 1 comprising an introduction compartment 2, in which a stack of banknotes 3 to be processed is provided, and a separator 8, which successively detects a respective banknote of the introduced stack and transfers it to a—merely schematically represented—transport device 10 (transport belts and/or transport rollers), which transports the banknote past an optical sensor 25 in the transport direction x for the verification of said banknote.

The optical sensor 25 has an optical image sensor 20, which converts the luminescence intensities emitted by the banknote transported past into corresponding sensor signals. The optical excitation of the luminescence of the banknote is effected e.g. by means of excitation light sources 27, 28 arranged on both sides of the image sensor 20. However, it is also possible for only one of the light sources to be used. The image sensor 20 has e.g. one sensor linear array or a plurality of sensor linear arrays, e.g. for different spectral components of the luminescence light. The sensor linear array(s) is/are arranged transversely with respect to the transport direction x of the banknotes. The image sensor 20 is controlled by a control device (not shown) in such a way that it detects the luminescence of the banknote at a plurality of detection times in order to optically scan the banknote transported past. In this case, detection regions of the banknote that are arranged adjacently along the transport direction are captured successively over time. The successively captured detection regions of the banknote each correspond to an image point of the luminescence image.

The optical sensor 25 is arranged on the left-hand side of the transport path—as viewed in the transport direction x of the banknote. A further optical sensor 29 can be arranged opposite the optical sensor 25, on the right-hand side of the transport path, and likewise has an optical image sensor (not shown) and optionally illumination devices for the optical excitation of the banknote luminescence and optionally a dedicated evaluation device. The luminescence image recorded by the optical image sensor of the optical sensor 29 situated opposite is optionally transmitted to the evaluation device 19 of the optical sensor 25 in order to enable joint evaluation of both luminescence images of the same banknote.

The image sensor 20 forwards the recorded luminescence image to the evaluation device 19 of the optical sensor 25. The evaluation device 19 can be contained in the housing of the optical sensor 25 or else outside that, e.g. in the value document processing apparatus 1. The evaluation device 19 determines the respective local fiber characteristic value of one or more locations, e.g. of one or more partial images, of the luminescence image recorded by the image sensor 20. On the basis of the local fiber characteristic values, the authenticity of the banknote is verified and the banknote is possibly classified as suspected counterfeit.

For one or more value document types, information about the grid points or partial images and optionally about expected values can be stored in a data memory 26 of the evaluation device 19. Information about the value document type to be verified in each case and optionally about the transport position of the value documents 3 can be communicated to the evaluation device 19 by the control device 50 of the apparatus 1.

Depending on the authenticity of the respective banknote ascertained by the evaluation device 19, the transport device 10 and also the diverters 4 and 5 along the transport path are controlled by the control device 50 in such a way that the banknote is fed to one of a plurality of dispensing compartments 30 and 31 and is placed there. By way of example, banknotes which were recognized as authentic are placed in a first dispensing compartment 30, while banknotes categorized as suspected counterfeit are placed in a second dispensing compartment 31. At the end of the illustrated transport path (reference numeral 6), further dispensing compartments and/or other devices can be provided, for example for storing or for destroying banknotes and/or a reject compartment, into which banknotes are placed for a separate treatment, for example by an operator.

In the example illustrated, the value document processing apparatus 1 furthermore comprises an input/output device 40 for the input of data and/or control commands by an operator, for example by means of a keyboard or a touchscreen, and for the output or display of data and/or information concerning the processing process, in particular concerning the banknotes processed in each case.

1^{st} exemplary embodiment

FIG. 3a shows by way of example the fiber distribution of luminescent fibers of an authentic banknote 80 of currency A, denomination 10. Moreover FIG. 3b shows an example of the fiber distribution of a composed counterfeit 66 with respect to this banknote 80. The composed counterfeit 66 is a composition of a part 82 of an authentic banknote, which has a mean fiber density of 1/cm², and a counterfeit part 62, which has no fibers at all.

For evaluation purposes, firstly the fibers are localized in the luminescence image recorded by the optical sensor 25. The luminescence image is then scanned systematically in a grid of e.g. 2×4 grid points. In the first exemplary embodiment, the fiber density is used as a local fiber characteristic value. For each grid point, the local fiber density in a surrounding region lying around the respective grid point is determined in each case, said region corresponding to a partial image of the banknote image. In the example in FIGS. 3d,e,f, the surrounding regions/partial images 11-14, 21-24 are distributed over the banknote in a grid comprising 2 rows and 4 columns. The 8 grid points lie e.g. in the respective center of the respective surrounding region or partial image. In the evaluation device 19 of the optical sensor 25, the grid of the partial images 11-14, 21-24 is fixedly predefined for a plurality of banknote types. The area content of the partial images is e.g. F=8 cm². It is assumed that the optical sensor 25 is configured for verifying banknotes of currencies A and D in which all denominations have fibers with a distribution that is uniform, but random over the banknote, with a specific mean area density (expected density value).

The optical sensor 25 acquires information about the banknote type to be verified from the value document processing apparatus 1 or from another sensor of the value document processing apparatus 1. A table stored in the data memory 26 of the evaluation device 19 stipulates which of the predefined partial images 11-14, 21-24 are actually intended to be examined for the respective banknote type, cf. table 1. In accordance with table 1, all partial images of the P t and 2n d columns are intended to be verified for currency A, denomination 10, and only 7 of the possible 8 partial images (partial image 24 is omitted) for currency A, denomination 50. With the aid of the information made available to the optical sensor 25 regarding the banknote type to be verified, the evaluation device 19 can select one or more of the possible partial images for evaluation purposes depending on the banknote type.

The expected density value DE of the fibers is also indicated for the respective banknote type in stored table 1.

TABLE 1
for currencies A and D, denominations 10 and 50 in each case

| | Expected density | Partial images to |
|---|---|---|
| | value DE | be verified |
| Currency A, | 1/cm² | 11-14, 21-24 |
| denomination 10 | | |
| Currency A, | 1/cm² | 11-14, 21-23 |
| denomination 50 | | |
| Currency D, | 5/cm² | 11-14, 21-24 |
| denomination 10 | | |
| Currency D, | 2/cm² | 11-14, 21-24 |
| denomination 50 | | |

The acceptable fluctuation range S for the fiber density can be fixedly predefined or be calculated depending on the expected density value and depending on the area content, e.g. S=0.5/cm^{2.}

On the basis of the recorded value document image, the evaluation device 19 of the optical sensor 25 determines the fiber number N in each of the partial images to be verified and with the aid of the area content F calculates therefrom the respective fiber density D=N/F. It then compares the latter with the respective expected density value DE, with DE=1/cm² in the case of currency A, for each of the partial images to be verified. This involves verifying whether the fiber density D is in the range DE+/−S. For the case of currency A, denominations 10 and 50, in accordance with table 1, this involves e.g. verifying whether the fiber density in the partial images is in the range E+/−S=1+/−0.5/cm², i.e. between 0.5/cm² and 1.5/cm². If this is the case, the respective partial image or the banknote is categorized as not suspicious. If the fiber density D is greater or less than DE+/−S, the respective partial image or the banknote is classified as suspected counterfeit.

The composed counterfeit 66 from FIGS. 3b, 3e is a composed counterfeit with respect to currency A, denomination 10. The latter means verifying all the partial images 11-14 and 21-24 according to table 1. No fibers are found (fiber density D=0) in the two partial images 11 and 21 and the latter are therefore categorized as suspicious. In the case of the partial images 12 and 22, the fiber density D is still in the acceptable range DE+/−S, and so these partial images are not categorized as suspicious. Moreover in the case of the partial images 13, 14, 23, 24, too, a fiber density D in the range DE+/−S is found in each case and these partial images are categorized as not suspicious. On account of the two partial images 11 and 21 categorized as suspicious, the composed counterfeit 66 from FIGS. 3b, 3e is classified as suspected counterfeit.

The composed counterfeit 67 from FIGS. 3c, 3f is a counterfeit with respect to currency A, denomination 50. Both the authentic banknote and the counterfeit 67 have a luminescent security element in the region 68. Said security element outshines the luminescence of the luminescent fibers in the luminescence image. Table 1 reveals the evaluation device 19 of the optical sensor 25 that for currency A, denomination 50—in contrast to denomination 10 of currency A—the fiber density is verified only in the partial images 11-14 and 21-23, but is not verified in the partial image 24 (which lies in the region of the luminescence element 68). The verification results of the partial images 11-14 and 21-23 correspond to those of the counterfeit 66 from FIGS. 3b,3e.

If the transport position of the banknotes is variable, the sensor can acquire information about the transport position of the banknote and, on the basis of the transport position, determine the partial images in which the fiber density is intended to be verified. For this purpose, in table 1 the information about the partial images to be verified can be stored for up to four transport positions of the respective banknote type. In the course of sensor adaptation, in order to create table 1 extended in this way, it is possible to ascertain in which of the partial images 11-14, 21-24 the luminescence element 68 is situated in the context of the respective transport position and must therefore be omitted in the course of the verification. By way of example, in the context of a different transport position of the composed counterfeit 67 where the luminescence element 68 is at the bottom left in the luminescence image, the partial image 21 would be omitted instead of the partial image 24.

2^{nd} exemplary embodiment

FIG. 2a shows by way of example the fiber distribution of luminescent mottled fibers of an authentic banknote 70 of currency B. The banknote 70 has mottled fibers only in the left-hand half, specifically with a mean area density of 1/cm². The right-hand half of the banknote 70 does not have any mottled fibers. In this example, the sensor does not acquire information about the banknote type to be verified, but rather is fixedly set to currency B, the denominations of which all have such a fiber distribution.

Independently of the banknote type, in the evaluation device 19, a single partial image 11 in the left-hand half of the banknote is always defined for all denominations of currency B, cf. FIG. 2b. The area content of said partial image can be fixedly predefined, e.g. as 10 cm². However, it is also possible to choose the area content or the size depending on the expected density value (given by the known mean area density) which is known for currency B and which is stored in the evaluation device 19. Assuming that the expected value E should be 10, then a partial image 11 with an area content of 10 cm² should be chosen given an expected density value of 1/cm^{2.}

For evaluation purposes, firstly the fibers are localized in the recorded luminescence image. In the second exemplary embodiment, the number of fibers localized in a partial image 11 is used as a local fiber characteristic value. FIG. 2c shows a counterfeit 64 with respect to a banknote of currency B, which has no mottled fibers at all. The fiber number N=0 is then determined in the partial image 11. However, since a fiber number of more than zero (E>0) is expected in the partial image 11 for currency B, the counterfeit 64 from FIG. 2c is classified as suspected counterfeit.

In order also to find counterfeits with an incorrect number of fibers, a more accurate verification can be carried out in which the fiber number N of the respective partial image is compared with the expected value E for the number: in the case of a banknote to be verified, the number N of mottled fibers in the partial image 11 is then determined and compared with the predetermined expected value, e.g. E=10. Preferably, in the context of the comparison, an exact correspondence to the expected value is not demanded, rather an acceptable fluctuation range S around the expected value E is permitted, e.g. S=5. The comparison involves verifying whether or not the fiber number N is in the range E+/−S. If it is not, the banknote is classified as suspected counterfeit, and if it is, the banknote is classified as not suspected counterfeit.

In the concrete example, where E=10 and S=5, the banknote is classified as follows depending on the fiber number N:
if no or up to 4 mottled fibers are contained (as in the case of counterfeit 64 from FIG. 2c): suspected counterfeit
if 5 to 15 mottled fibers are counted (as in the case of the authentic banknote 70 from FIGS. 2a,b): not suspected counterfeit
if more than 15 mottled fibers are counted: suspected counterfeit.

If the transport position of the banknotes is variable in the case of the value document processing apparatus, information about the transport position can be communicated to the optical sensor 25, on the basis of which said optical sensor defines the position of partial image 11 in such a way that the partial image 11 lies in a banknote section in which the fibers are present in the case of the authentic banknote 70. In the context of the transport position from FIGS. 2a,b, the partial image 11 is therefore put into the left-hand half of the value document image of the banknote 70. In the context of a different transport position of the banknote 70 where the fibers are on the right in the value document image, the partial image 11 would be positioned in the right-hand half of the value document image.

3^{rd} exemplary embodiment

FIG. 4a shows an authentic banknote 90 of currency C, denomination 50, which has fibers distributed approximately uniformly over the banknote with a mean area density (expected density value) of 0.66/cm², which applies to all denominations of currency C.

Moreover FIG. 4b shows an example of the fiber distribution of a composed counterfeit 65 with respect to the banknote 90, in the case of which a part 92 of an authentic banknote is combined with a counterfeit part 63, in which there is a lower fiber density than in the case of the authentic banknote. The authentic part 92 has e.g. a mean fiber density of 0.67/cm², with that of the counterfeit part 63 being 0.1/cm^{2.}

Owing to the mean area density of the fibers known to be lower, the evaluation device 19 defines partial images with a larger area content for currency C than for currency A.

In the course of sensor adaptation, a table 2 with a partial image definition (position and dimensions), an expected value E and an acceptable fluctuation range S for each partial image was determined for each banknote type to be verified by the sensor, cf. in table 2. The respective area content is found by multiplying the partial image width dx and the partial image height dy. The partial images 11, 12, 21, 22 from table 2 all have the same shape and size, cf. FIG. 4c.

TABLE 2
for currency C, all denominations

| | Partial image | | Partial | | |
|---|---|---|---|---|---|
| Partial | coordinates | Partial | image | | Fluctu- |
| image | (x, y) (top | image width | height | Expected | ation |
| number | left corner) | dx in mm | dy in mm | value E | range S |
| 11 | 5, 5 | 60 | 40 | 16 | 5 |
| 12 | 5, 50 | 60 | 40 | 16 | 5 |
| 21 | 70, 5 | 60 | 40 | 16 | 5 |
| 22 | 70, 50 | 60 | 40 | 16 | 5 |

By virtue of the explicit partial image definitions in table 2, however, different partial image sizes on the same banknote are also possible. The expected values E and fluctuation ranges S are identical here for all the partial images 11, 12, 21, 22 since the area content thereof is identical. However, they can also be different, e.g. in the case of partial images having different area contents. With a larger area content, a larger fluctuation range S can also be permitted. Corresponding tables for other denominations or currencies to which other numerical values generally apply are also stored in the optical sensor 25. In the case of nonuniformly distributed fibers, such as e.g. in the case of the banknote 70 of currency B from FIG. 2a, the corresponding table would contain different expected values E for different partial images.

The acceptable fluctuation range S can be indicated in the table. It can also be calculated only depending on the expected value E, e.g. 40% of the expected value E, or be settable for the operator of the value document processing apparatus.

The optical sensor 25 acquires information about the banknote type to be verified, i.e. currency C and optionally the denomination, from the value document processing apparatus 1 or from another sensor. With the aid of the information about the banknote type to be verified, the evaluation device 19 obtains from table 2 the information about the partial images that are predetermined for the banknote type to be verified.

For evaluation purposes, once again the fibers are firstly localized in the luminescence image recorded by the optical sensor 25. On the basis of the recorded luminescence image of the banknote to be verified, e.g. the number N of fibers in each of these partial images 11,12,21,22 can be determined and compared with the respective expected value E+/−S. In the example of currency C, denomination 10, a fiber number of E+/−S in the range of 11 to 21 is expected in each of the partial images 11, 12, 21, 22. In the case of the composed counterfeit 65 in FIGS. 4b, 4d, 18 mottled fibers are actually found in the partial images 11 and 21, and so these partial images are not categorized as suspicious. For the partial images 12 and 22, by contrast, in each case a low number of mottled fibers of 8 and 10, respectively, is found and these partial images are therefore categorized as suspicious. Since at least one partial image is categorized as suspicious (12 and 22), the composed counterfeit 65 from FIGS. 4b, 4d is classified as suspected counterfeit with regard to a composed counterfeit.

In addition or as an alternative to the number of fibers in the respective partial image, it is also possible to use a constitution of the fibers in the respective partial image as a local fiber characteristic value, such as e.g. the length of the fibers, their aspect ratio (width-length ratio), the shape or the color of the fibers, or the respective mean value of said constitution over the respective partial image, or the dispersion of said constitution around said mean value in the respective partial image. Conspicuous partial images can then be identified, the constitution or mean value or dispersion of which deviates from a reference value (by more than an acceptable fluctuation range). Moreover the value document is classified as suspected counterfeit if one or more partial images that are conspicuous in this regard were found.

4^{th} exemplary embodiment

The fourth exemplary embodiment considers a banknote with fibers distributed uniformly over the banknote, such as e.g. the banknote 90 of currency C in FIG. 4a.

For evaluation purposes, once again the fibers are firstly localized in the luminescence image recorded by the optical sensor 25 and the number N of fibers in each of the partial images 11,12,21,22 is determined.

In contrast to the third exemplary embodiment, however, the expected value E for the number of fibers is not stored in the sensor, i.e. is not predefined, but rather is determined only in the course of verification of the respective banknote. A relative verification of the number of fibers of at least two different partial images is carried out, wherein the number of fibers of at least one specific partial image defines the expected value E for the other partial image(s).

For example, in the case of the banknote 90 of currency C from FIG. 4c, the fiber number of the partial image 11 (e.g. N=18) can predefine the expected value E for the other partial images 12, 21 and 22, i.e. E=18. The fiber number N of the partial images 12, 21, 22 is compared with E=18. In the case of a difference of more than the acceptable fluctuation range S (with S=4, e.g. a fiber number in the range 14-22 is expected), the banknote to be verified is classified as suspected counterfeit. This then results in the following for the counterfeit 65 from FIGS. 4b, 4d:
Partial image 11: N=18, is defined as expected value E,
Partial image 12: 10 fibers, suspected counterfeit,
Partial image 21: 17 fibers, not suspected counterfeit,
Partial image 22: 9 fibers, suspected counterfeit.

In the case of uniformly distributed fibers and partial images having identical areas, such as the partial images 12, 12, 21 22 from FIGS. 4c, 4d, the expected value used for one of the partial images can also be the average fiber number of the other partial images 12, 21 and 22: in this regard, e.g. the average fiber number of the partial images 12, 21 and 22 can be used as expected value for partial image 11, which results in E=12 in the above example. With a fluctuation range of S=4, a fiber number of 8-16 is expected. The deviation of the fiber number in partial image 11 (N=18) is then categorized as suspicious.

In an additional verification, the average fiber number of the partial images 11, 12 and 21 can be used as expected value for the partial image 22, which results in E=15 in the above example. With a fluctuation range S=4, a fiber number of 11-19 is expected and the deviation of partial image 22 (N=9) is categorized as suspicious.

5^{th} Exemplary Embodiment

A banknote having luminescent fibers is considered in the fifth exemplary embodiment. In the value document processing apparatus 1, two luminescence images of the banknote are recorded from opposite sides and the fibers imaged there are localized.

As an example, the banknote 70 of currency B from FIG. 2a is considered, which has luminescent fibers only in its left-hand half. In the course of the verification in the value document processing apparatus 1, the optical sensor 25 records a luminescence image of the banknote front side of the banknote 70, cf. FIG. 5a, and the optical sensor 29 situated opposite simultaneously records a luminescence image of the banknote rear side of the banknote 70, cf. FIG. 5b.

Since the luminescence light is usually greatly attenuated by the value document substrate, on the respective side normally only the luminescence light of the fibers lying on or directly beneath the value document surface is capturable, but not the luminescence light of the fibers located deeper in the substrate or on the other side of the value document. The luminescent fibers of the front side are therefore recognizable only in the luminescence image of the banknote front side, but not in the luminescence image of the banknote rear side, and vice versa.

The verification of both opposite luminescence images enables a particularly accurate verification of the banknote on both sides, which involves determining the local fiber characteristic value for two mutually corresponding partial images of the opposite sides of one and the same banknote section.

In the front side image of the banknote 70, e.g. the number N1 of luminescent fibers is determined in a partial image 11, cf. FIG. 5a. In the rear side image of the banknote 70, a partial image 11′ is defined which is congruent with the partial image 11 of the front side image and covers exactly the same banknote section as the partial image 11 of the front side. The partial images 11 and 11′ thus show the front and rear sides of one and the same banknote section. For example, the two partial images 11, 11′ lie in the white field of the banknote 70. A number N2 of luminescent fibers is determined for the partial image 11′ of the rear side.

The sum of luminescent fibers of both partial images 11, 11′ yields the total number (Nₜₒₜ=N1+N2) of fibers contained in total in the respective first partial image 11 and in the respectively corresponding second partial image 11′. In the case of the authentic banknote 70, e.g. a sum of 20 fibers is expected (i.e. expected value E=20) for the sum of the luminescent fibers. The banknote that is verified is then classified as suspected counterfeit or not suspected counterfeit, depending on the total number Nₜₒₜ.

If, in the case of a composed counterfeit, for example, in the left-hand part of the banknote 70, for example, the authentic banknote was replaced by a piece of paper without luminescent fibers, then a total number of N tot=0 luminescent fibers would be correspondingly determined both in the partial image 11 and in the partial image 11′ and the composed counterfeit would thus be segregated. The total number N tot of fibers can be compared with the expected value E=20 and can be classified as suspected counterfeit in the case of an excessively large deviation from E (more than the acceptable fluctuation range S), and as not suspected counterfeit in the case of only little deviation. However, it is also possible to use other local fiber characteristic values for verifying the partial images 11, 11′ corresponding to one another.

6^{th} Exemplary Embodiment

The sixth exemplary embodiment considers the composed counterfeit 65 from FIG. 4b, which is a counterfeit of the banknote 90 from FIG. 4a, wherein one part 92 of an authentic banknote is combined with a counterfeit part 63 with a lower fiber density.

For evaluation purposes, once again the fibers are firstly localized in the luminescence image recorded by the optical sensor 25. The luminescence image is then scanned systematically in a grid of grid points R. In the example in FIG. 6a, the grid points R are distributed over the banknote in a grid comprising 3 rows and 9 columns.

As a local fiber characteristic value of the respective grid point, the distance a from the respective grid point R to the closest fiber in each case is used, cf. FIG. 6a, and is compared with a reference distance chosen depending on the expected density value DE of the fibers. Those grid points whose distance a is greater than the reference distance are categorized as conspicuous. The value document is then categorized as suspected counterfeit e.g. depending on whether one or more conspicuous grid points are found in the banknote image, or e.g. depending on whether one or more conspicuous regions having a plurality of conspicuous (e.g. a minimum proportion of conspicuous) grid points are found. The classification of the value document as suspected counterfeit can also be effected depending on the position of the conspicuous grid points or regions on the value document.

In the example of the composed counterfeit 65 from FIG. 6a, the two columns of grid points on the right each have many grid points that are conspicuous in this regard, and form a conspicuous region. The composed counterfeit 65 is therefore classified as suspected counterfeit.

7^{th} exemplary embodiment

The seventh exemplary embodiment is also based on the grid points R described in the sixth exemplary embodiment, cf. FIG. 6b.

For the purpose of evaluating the luminescence image, each localized fiber is assigned an (areal) effect region W, cf. the areas marked in gray in FIG. 6b. The effect region W is a region around the respective fiber which is defined only for the purpose of the evaluation, and which is not physically present on the value document, however. In the example shown, circular effect regions W are defined around the respective fiber, which is situated within (e.g. in the center of) the effect region W assigned to it. The size or area of the effect region W is preferably defined depending on an expected density value DE of the fibers. By way of example, the area F of the effect regions W is chosen by means of the formula F=K/DE, where K is a numerical factor. For example, with a numerical factor K=1, the effect region area can be chosen with a magnitude such that, in the case of a fiber density that is equal to the expected density value, the sum of the areas of all the effect regions corresponds to the banknote area.

By way of example, the association (yes/no) of the respective grid point R with one or more of the effect regions W around the fibers is used as a local fiber characteristic value. For each grid point, a check is thus made to establish whether or not said grid point lies in one or more of the effect regions W. If it does, the respective grid point is classified as associated with an effect region, and if it does not, the respective grid point is classified as not associated with an effect region.

This is then followed by searching for one or more conspicuous regions of the value document image in which the number or the proportion of grid points which were classified as not associated with an effect region is greater than expected. In the example from FIG. 6a, in the two columns on the right that lie in the counterfeit part 63 of the composed counterfeit 65, the proportion of grid points which were classified as not associated with an effect region is in each case 3 out of 4 grid points, corresponding to 75%. This proportion is compared e.g. with a reference proportion (e.g. 50%) and, in the event of the reference proportion being exceeded, the respective column of the grid is categorized as conspicuous. The reference proportion can be predetermined or settable or can be determined depending on the proportions of grid points not associated with an effect region in other banknote regions. For example, the proportion of the grid points not associated with an effect region in the respective right-hand columns can be compared with the mean proportion of grid points not associated with an effect region that is ascertained for a plurality of the left-hand columns of the grid.

The value document can then be classified as suspected counterfeit depending on whether one or more conspicuous columns are found. In this regard, the composed counterfeit 65 is classified as suspected counterfeit owing to the two conspicuous right-hand columns.

8^{th} exemplary embodiment

The eighth exemplary embodiment is also based on the grid points R described in the sixth exemplary embodiment and on the effect regions W used in the seventh exemplary embodiment.

Each of the grid points R is assigned an (areal) surrounding region 111-119, 121-129, 131-139, 141-149 around the respective grid point, said surrounding region corresponding to a partial image of the banknote image, cf. FIG. 6c. The surrounding regions 111-119, 121-129, 131-139, 141-149 overlap one another. The grid points R lie e.g. in the center of the respective surrounding region.

That proportion of the respective surrounding region around the respective grid point which is constituted by the area (gray or dark gray) covered by at least one effect region W or which is constituted by the area (white) not covered by at least one effect region is used as a local fiber characteristic value. For this purpose, in the respective surrounding region, it is possible to identify coverage regions (gray or dark gray in FIG. 6c) which belong to the effect region of at least one of the fibers (these may be fibers within or outside the respective surrounding region, the effect region of which fibers lies partly in the surrounding region). Alternatively or additionally, in the respective surrounding region, it is possible to identify free regions (white) which do not belong to an effect region of at least one of the fibers. Alternatively or additionally, in the respective surrounding region, it is also possible to identify overlap regions in which the effect regions of (adjacent) fibers overlap (dark gray).

On the basis of the size of the respective coverage region and/or free region and/or overlap region, a local fiber characteristic value of the respective surrounding region is determined. The local fiber characteristic value used can be e.g.
that area proportion of the respective surrounding region which is constituted by the (gray) coverage regions (e.g. percentage indication), or
that area proportion of the respective surrounding region which is constituted by the (white) free regions (e.g. percentage indication), or
that area proportion of the respective surrounding region which is constituted by the (dark gray) overlap regions (e.g. percentage indication), or
the area content of the coverage regions and/or the area content of the free regions and/or the area content of the overlap regions.

The value document is then classified as suspected counterfeit depending on one or more of these proportions or area contents which were ascertained for the examined surrounding regions of the value document.

For example, the respective proportion or area content of the respective surrounding region can be compared with a reference value and, in the event of the reference value being exceeded, the respective surrounding region can be categorized as conspicuous. In the case of the composed counterfeit 65, e.g. the surrounding regions 118, 119, 128, 129, 138, 139, 147, 148, 149 are conspicuous in this regard. The value document can then be classified as suspected counterfeit depending on whether one or more conspicuous surrounding regions are found.

Alternatively, it is also possible to determine the mean value of the proportions or area contents of all the surrounding regions of the value document image and to evaluate the dispersion of the proportions or area contents around said mean value. In the event of excessively great dispersion, the value document would be segregated as suspected counterfeit.

1-17. (canceled)

18. A sensor for verifying a value document which comprises a multiplicity of fibers distributed over the value document, and which is brought into a capture region of the sensor for the purpose of verifying said value document,
wherein the sensor comprises:
an image capture device configured to capture a value document image of the value document,
wherein the value document image shows a characteristic optical or magnetic signal of the fibers, and
an evaluation device, which, for the purpose of evaluating the value document image, is configured,
to localize the fibers contained in the respective value document image, and
to ascertain for one or more different locations of the value document image in each case at least one local fiber characteristic value which applies to the respective location and optionally to surroundings of the respective location on the value document image, and
to classify the value document as suspected counterfeit depending on the at least one local fiber characteristic value.

19. The sensor according to claim 18, wherein the evaluation device, for the purpose of evaluating the value document image, is configured to scan the value document image point by point using grid points,
wherein a local fiber characteristic value is ascertained for each grid point of the value document image, and to classify the value document as suspected counterfeit depending on the local fiber characteristic values ascertained for the grid points.

20. The sensor according to claim 19, wherein the evaluation device, for the purpose of evaluating the value document image, is configured:
to identify one or more conspicuous grid points which are conspicuous with regard to the local fiber characteristic value ascertained at the respective grid point,
to identify one or more conspicuous regions of the value document image in which conspicuous grid points are situated, and
to classify the value document as suspected counterfeit depending on one or more properties of the respective conspicuous region and/or depending on the local fiber characteristic values which were ascertained for the grid points of the respective conspicuous region.

21. The sensor according to claim 19, wherein the evaluation device,
for the purpose of evaluating the value document image, is configured to ascertain the local fiber characteristic value ascertained for the respective grid point of the value document image for a surrounding region assigned to the respective grid point, or, for the purpose of evaluating the value document image, is configured to ascertain the respective local fiber characteristic value ascertained for the respective grid point of the value document image pointwise for the respective grid point.

22. The sensor according to claim 21, wherein the evaluation device, for the purpose of evaluating the value document image, is configured:
to determine one or more partial images of the value document image, each of which contains a segment of the value document image,
wherein the respective partial image of the value document image is a surrounding region around a respective one of the grid points,
to determine the local fiber characteristic value for the respective partial image,
to classify the value document as suspected counterfeit depending on the local fiber characteristic value(s) of one or more of the partial images.

23. The sensor according to claim 18, wherein the local fiber characteristic value used is a measure of local density of the fibers,
wherein the number of fibers situated in the surroundings of the respective location, the respective partial image or in the respective surrounding region around a grid point, or
the fiber density in the surroundings of the respective location, in the respective partial image or in the respective surrounding region, or
a distance measure characteristic of the distance between the fibers of the fibers in the surroundings of the respective location, including a mean distance of the fibers of the partial image or of the surrounding region from the fiber that is the most closely adjacent to the respective fiber.

24. The sensor according to claim 22, wherein the evaluation device is configured to determine at least two partial images of the value document image which together cover at least 50% of the area of a value document side of the value document, wherein the partial images are arranged in rows and/or in columns on the value document,
wherein the partial images are arranged in a grid composed of at least two rows and/or at least two columns on the value document.

25. The sensor according to claim 18, wherein the local fiber characteristic value used is a measure of the local constitution of the fibers at the respective location and optionally in the surroundings of the respective location, which concerns the shape or size or color or brightness of the fibers at the respective location and optionally in the surroundings of the respective location,
wherein the local fiber characteristic value used is a representative value of the local constitution of the fibers at the respective location and optionally in the surroundings of the respective location.

26. The sensor according to claim 18, which is configured, on the basis of one or more properties of the fibers localized in the value document image and/or on the basis of one or more of the local fiber characteristic values of the respective value document which were ascertained for the different location(s) of the value document image, to determine individual fingerprint data of the respective value document, to assign the individual fingerprint data to processing data of the respective value document and to store them together with the processing data of the respective value document, optionally in a list for a plurality of value documents, in each case in a manner assigned to one another.

27. The sensor according to claim 18, wherein the evaluation device has information about the value document type of the value document to be verified and is configured to determine those locations of the value document image for which the respective local fiber characteristic value is determined depending on the value document type of the value document to be verified, to carry out the determining of the partial images depending on the value document type of the value document to be verified,
wherein a plurality of partial images are fixedly predefined in the evaluation device and the evaluation device is configured to determine specific partial images for evaluation purposes from these fixedly predefined partial images depending on the value document type of the value document to be verified.

28. The sensor according to claim 18, wherein
the sensor is configured for verifying value documents of one or more specific value document types, the value documents of which comprise in each case at least one disturbing security element which adversely affects the capture of the characteristic optical or magnetic signal of the fibers, and
the evaluation device of the sensor is configured to classify the value documents of the specific value document type as suspected counterfeit depending on the at least one local fiber characteristic value of only one or a plurality of such locations of the value document image at which the capture of the optical or magnetic signal of the fibers is not adversely affected by the at least one disturbing security element.

29. The sensor according to claim 18, wherein the evaluation device, for the purpose of evaluating the value document image, is configured:
to assign an effect region to each of the localized fibers,
for a plurality of different locations of the value document image to analyze in each case locally the effect regions of the fibers present at the respective location and optionally in the surroundings thereof, with regard to the area covered or not covered by the effect regions or with regard to the overlap of adjacent effect regions, and
to ascertain the respective local fiber characteristic value of the respective location on the basis of the local analysis of the effect regions which lie at the respective location and optionally in the surroundings thereof,
wherein the evaluation device, for the purpose of evaluating the value document image, is configured to choose the size of the effect regions in each case depending on an expected density value indicating the area density of the fibers that is expected for the value document image and optionally for the respective location of the value document image.

30. The sensor according to claim 27, wherein the evaluation device, for the purpose of evaluating the value document image, is configured:
to assign an effect region to each of the localized fibers of the value document image or of the respective partial image or of the respective surrounding region and
to identify coverage regions which belong to the effect region of at least one of the fibers, and/or
to identify free regions which do not belong to any effect region of at least one of the fibers, and/or
to identify overlap regions in which the effect regions of at least two adjacent fibers overlap, and
to identify one or more conspicuous regions of the value document image which are conspicuous with regard to their coverage regions and/or free regions and/or overlap regions, and
to classify the value document as suspected counterfeit depending on one or more properties of the coverage regions and/or the free regions and/or the overlap regions in/at one or more conspicuous regions of the value document image.

31. The sensor according to claim 18, wherein the evaluation device, for the purpose of evaluating the value document image, is configured:
for one or a plurality of locations of the value document image to compare the local fiber characteristic value of the respective location with an expected value,
wherein the expected value, for the respective value document, and optionally for the respective location of the respective value document,
is predetermined or
the evaluation device is configured to determine the expected value with which the local fiber characteristic value of the respective location is compared on the basis of the local fiber characteristic values which are ascertained for one or more other locations of the same value document image, and
to classify the value document as suspected counterfeit depending on the comparison results obtained for one or more locations of the value document image, depending on a difference established during the comparison between the local fiber characteristic value of the respective location and the expected value.

32. The sensor according to claim 18, wherein the value document image is a first value document image, which is captured from a first value document side of a value document to be verified, and the evaluation device has a second value document image, which is or was captured from the second side—opposite the first side—of the same value document, and the evaluation device is configured:
to determine in each case at least one local fiber characteristic value for at least one first partial image of the first value document image and for at least one second partial image of the second value document image, and
optionally to combine the local fiber characteristic value of the first partial image and the local fiber characteristic value of the second partial image with one another or to compare these with one another, and
to classify the value document as a suspected counterfeit depending on the local fiber characteristic value of the first partial image and depending on the local fiber characteristic value of the second partial image, depending on a result of the combination or depending on a result of the comparison,
wherein the second partial image is a second partial image which corresponds to the first partial image, and which is a segment of the second value document image,
wherein the first partial image and the corresponding second partial image contain the optical or magnetic signals of the front and rear sides of the same value document section of the value document.

33. A value document processing apparatus comprising:
a sensor according to claim 18, and
a transport device for introducing the value documents into the capture region of the sensor.

34. A method for verifying a value document with the aid of a sensor, with the aid of the sensor according to claim 18,
wherein the value document comprises a multiplicity of fibers distributed over the value document, and
wherein the following steps are carried out in the method:
introducing the value document into the capture region of the sensor and capturing a value document image of the value document with the aid of an image capture device of the sensor,
wherein the value document image contains a characteristic optical or magnetic signal of the fibers,
evaluating the value document image with the aid of an evaluation device of the sensor, which evaluation device for the purpose of evaluating the value document image, is configured:
to localize the fibers contained in the respective value document image, and
to ascertain for one or more different locations of the value document image in each case at least one local fiber characteristic value which applies to the respective location and optionally to surroundings of the respective location, and
to classify the value document as suspected counterfeit depending on the at least one local fiber characteristic value.
